(19) United States
(12) Patent Application Publication
(10) Pub. No.: US 2007/0137716 A1
(43) Pub. Date: Jun. 21, 2007

(54) Foam eductor

(76) Inventors: Kyle Alden Stoops, Elkhart, IN (US); Anthony M. Van Es, Granger, IN (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/605,072

(22) Filed: Nov. 28, 2006

Related U.S. Application Data
(60) Provisional application No. 60/742,760, filed on Dec. 5, 2005.

(51) Int. Cl. B05B 7/26; A62C 5/02; B01F 5/04

(52) U.S. Cl. 137/893; 239/310; 239/10

(57) ABSTRACT

An inline foam eductor includes a first conduit having an upstream end, a downstream end, and a restriction between the upstream end and the downstream end, a second conduit in fluid communication with the first conduit downstream of the restriction between the restriction and the downstream end of the first conduit wherein fluid flowing through the first conduit through the restriction generates a venturi effect to thereby form a vacuum pressure in the second conduit, and a foam supply conduit in fluid communication with the second conduit. A metering device is operable to reduce the vacuum pressure in the second conduit to adjust the amount of foam drawn from the foam supply conduit into said first conduit through the second conduit.

### CROSS-REFERENCE TO RELATED APPLICATIONS

This application claims priority and the benefit of provisional application entitled FOAM EDUCTOR, Ser. No. 60/742,760, filed Dec. 5, 2005, which is incorporated herein by reference in its entirety.

### TECHNICAL FIELD AND BACKGROUND OF THE INVENTION

The present invention relates to a foam proportioning system and, more specifically, to an inline foam eductor that is used to mix firefighting foam with a stream of water to produce a foam/water mixture for firefighting purposes.

Conventional foam eductors are placed inline between two fluid delivery devices or conduits, typically two fire hoses. The eductor typically includes an internal diameter of changing magnitude to form a restriction between its input end and its discharge end, which creates a venturi effect downstream of the restriction. Typically, a foam is introduced to the eductor downstream of the restriction so that the venturi effect, which creates a vacuum, draws the foam into the eductor. The amount of foam that is drawn into the eductor is controlled by a metering device with an adjustable or fixed orifice. In this manner, the percentage of foam that is introduced into the water is controlled based on the size of the orifice. As it would be understood by those skilled in the art, when the orifice size is reduced, less foam will be drawn up into the eductor. To increase the percentage of foam, the orifice size is enlarged to allow more foam to flow into the eductor. Hence, the current market metering devices rely on a constant vacuum pressure and, as noted, rely on the change in the orifice size to achieve the different percentage of the foam in the foam/water mixture.

In order to reduce the amount of foam needed for a given application, the concentration of active foaming agents in current liquid foams has been increased, which has resulted in a corresponding increase in the viscosity or thickness of the foam concentrate. With the higher concentration foams, less foam is needed. Hence, the orifice size must be correspondingly reduced. However, these thicker foams have tended to create problems with small orifice sizes because the orifices can become partially or fully blocked when using the thicker style foam.

Consequently, there is a need to provide a foam proportioning system that can accommodate thicker foams and yet still provide the control over the amount of foam that is introduced into the water to control the foam/water ratio.

### SUMMARY OF THE INVENTION

Accordingly, the present invention provides a foam eductor, which may be placed inline between two fluid delivery devices or conduits, that can accommodate foams with increased viscosity without the attendant problems associated with conventional fixed orifice eductor designs.

In one form of the invention, an inline foam eductor includes a first conduit, a second conduit, which is in fluid communication with the first conduit, and a foam supply conduit, which is in fluid communication with the second conduit. The first conduit includes a restriction between its upstream and downstream ends with the second conduit in fluid communication with the first conduit downstream of the restriction, between the restriction and the downstream end of the first conduit, wherein fluid flowing from the first conduit through the restriction generates a venturi effect to thereby form a vacuum pressure in the second conduit. The foam eductor also includes a metering device that is operable to introduce a fluid into the second conduit to adjust the vacuum pressure in the second conduit to thereby control the amount of foam drawn from the foam supply conduit into the first conduit through the second conduit.

In one aspect, the metering device is operable to introduce a fluid, such as air, into the second conduit to thereby reduce the vacuum pressure in the second conduit. For example, the metering device may comprise a valve, such as a needle valve or an air valve, as well as an electrically operated valve, such as a solenoid valve.

According to another aspect, the second conduit includes an orifice through which the foam supply conduit is in fluid communication with the second conduit. For example, the orifice optionally comprises a fixed diameter orifice wherein the eductor solely relies on a varying vacuum pressure to control the amount of foam drawn from the foam supply conduit rather than a fixed vacuum pressure and an orifice with an adjustable diameter to control the amount of foam drawn into the eductor.

In another form of the invention, an eductor includes a first conduit in fluid communication with a fluid delivery device, a second conduit in fluid communication with the first conduit, which has a vacuum pressure formed therein, and a device for selectively adjusting the vacuum pressure in the second conduit. A fluid supply is in fluid communication with the second conduit wherein the device selectively adjusts the vacuum pressure in the second conduit to thereby adjust the flow of fluid from the fluid supply to the second conduit and from the second conduit to the first conduit.

In one aspect, the device comprises a metering device, such as a valve, including an electrically controlled valve, such as a solenoid valve.

Optionally, the electrically controlled valve may be in communication with a control for controlling the electrically controlled valve. For example, the control may comprise a remote control that communicates with the electrically controlled valve through RF communication or through electrical wiring.

In another aspect, the device includes a removable insert, which has a fluid passageway in communication with the second conduit for allowing fluid flow, such as air or water flow, into the conduit to thereby vary the vacuum pressure in the second conduit. The insert is removable and optionally replaceable with another insert with a different size fluid passageway to vary the bleed-off rate of the vacuum pressure in the second conduit.

In yet another form of the invention, a method of educting a fluid, such as a foam or foam/water mixture, into a fluid delivery device, such as a fire fighting hose, includes providing a conduit in fluid communication with the fluid delivery device, providing fluid communication between the conduit and a fluid supply, forming a vacuum pressure in the conduit wherein fluid from the fluid supply is drawn into the conduit, and adjusting the vacuum pressure in the conduit to vary the flow of fluid into the conduit from the fluid supply and the flow into the fluid delivery device.

In one aspect, the vacuum pressure is adjusted by introducing a fluid, such as air or water, into the conduit.

In another aspect, the control of the flow of fluid into the conduit is controlled by a metering device, such as a valve, including an electrically controlled valve, such as a solenoid.

Further, the control of fluid into the conduit may be controlled by a control in communication with the metering device, including a remote control.

In this manner, the present invention controls the flow of foam without the attendant problems currently encountered when introducing thicker foams into an eductor. These and other objects, advantages, purposes, and features of the invention will become more apparent from the study of the following description taken in conjunction with the drawings.

### DESCRIPTION OF THE DRAWINGS

FIG. 1 is a schematic cross-section of an eductor of the present invention;

FIG. 2 is another embodiment of a metering assembly for the eductor of the present invention; and

FIG. 3 is a cross-section view taken along line III-III of FIG. 2.

### DETAILED DESCRIPTION OF THE PREFERRED EMBODIMENTS

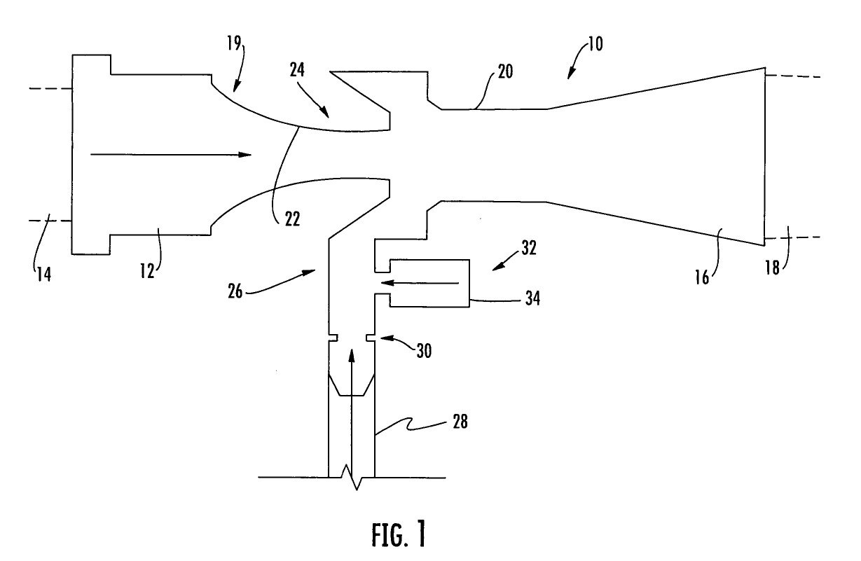

Referring to FIG. 1, the numeral 10 generally designates an inline foam eductor of the present invention. Although described in reference to the injection of a foam into the stream of water through the eductor, it should be understood that the eductor may be used to mix other fluids and is not just limited to the introduction of foam into water. As previously noted, eductor 10 is an inline eductor with an upstream end 12 for connection to a water supply device or conduit 14, such as a water supply hose, and a downstream end 16 for connection to a water/foam mixture discharge device or conduit 18, such as a water/foam mixture discharge hose. As will be more fully described below, eductor 10 is adapted to introduce foam into the stream of water as it flows through the eductor by varying the vacuum pressure generated in the eductor. While the eductor is described as being located or placed between two conduits, such as two fire hoses, it should be understood that the term conduit is used broadly and covers any component through which a fluid, such as water, flows. For example, eductor 10 may be placed at the outlet of the pump/truck connection between the outlet and the hose that attaches to the outlet. Further, the upstream end 12 (inlet) may be attached to a hose and the downstream end 16 (outlet) may be attached to a nozzle or a monitor or other fluid delivery device.

Eductor 10 is formed by two conduits 19 and 20 that are joined together. Conduit 19 includes upstream end 12, which is adapted for coupling to supply conduit 14, and has a downstream portion that has a varying cross-section 22, which forms a restriction 24. Conduit 20 includes an expanded portion and a downstream portion 16 for coupling to discharge conduit 18. Joined between conduits 19 and 20 is a second conduit 26, which is downstream of restriction 24 and forms a venturi effect that generates a vacuum pressure in conduit 26. The venturi is created by the water passing through conduit 19 and the restriction 24, which creates a jet of water. The jet of water passes over the open gap, which is formed in part by conduit 26, and flows into and fills the jet cone portion of conduit 20. The expanded portion in conduit 20 results in a downstream expansion of the flow in conduit 20, which creates an upstream vacuum in the gap—in other words in conduit 26.

Conduit 26 is in fluid communication with a foam supply conduit 28 through a fixed diameter orifice 30. To control the amount of foam that is drawn up from foam conduit 28 through orifice 30 into conduit 26, due to the vacuum pressure in conduit 26, eductor 10 further includes a metering device 32 that controls the amount of vacuum pressure in conduit 26.

In the illustrated embodiment, metering device 32 comprises a valve, such as a needle valve, that controls the flow of a fluid, such as air, into conduit 26 to vary the vacuum pressure in conduit 26 and, therefore, vary the amount of foam drawn from foam conduit 28 through orifice 30 into conduit 26 and, further, into conduit 20.

By providing an orifice 30 with a fixed diameter, the attendant problems associated with the thicker foams, which require smaller orifices, are eliminated. In contrast to a conventional eductor, the control over the introduction of the foam into eductor 10 is achieved through varying the vacuum pressure rather than solely through varying dimensions of the orifice or other geometric parameters.

As noted above, metering device 32 optionally may comprise a valve and, furthermore, preferably introduces air into conduit 26 to thereby reduce the vacuum pressure in conduit 26. Valve 34 may comprise an electrically controlled valve, such as a solenoid valve, which may be electrically hard-wired to a remote control or may be controlled through RF communication or the like.

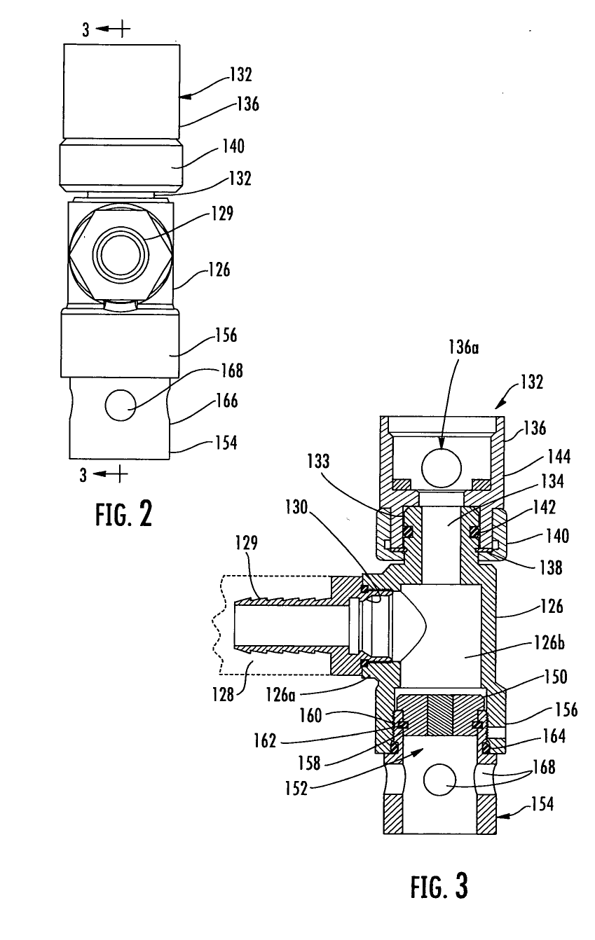

Referring to FIGS. 2 and 3, the numeral 132 generally designates another embodiment of the metering assembly, which is suitable for connection to conduit 20 upstream of restriction 24 described in reference to the previous embodiment. As will be more fully described below, metering device 132 bleeds off the vacuum pressure to control the flow of foam into the eductor and, further, provides for a removable insert that can vary the bleed-off rate of the vacuum.

Metering assembly 132 includes a conduit 126 that includes an inlet 126a for coupling to a foam conduit 128 through a coupling shank 129. Shank 129 includes an orifice 130 with a fixed diameter through which the foam flows, which eliminates the attendant problems associated with the thicker foams. To seal the connection between coupling shank 129 and inlet 126a, a seal is provided between coupling shank 129 and inlet 126a.

Conduit 126 includes a first chamber 126b with a first diameter and a reduced diameter neck 133, which forms a second chamber or passage 134 with a reduced diameter than of chamber 126b. Mounted to neck 133 of conduit 126 is a check ball adapter 136 and ball 136a, which is mounted to neck 133 by a retaining ring 138 and a connector nut 140. Positioned between check ball adapter 136 and neck 133 is an o-ring seal 142 to thereby seal the connection therebetween. Positioned in check ball adapter 136 is a gasket 144, which is compressed when check ball adapter 136 is mounted to the foam inlet connection of conduit 20 of the eductor to thereby seal the connection to conduit 20. In this manner, the venturi effect, which is created by the water flowing through the restriction in conduit 20, generates a vacuum in passageway 134 and cavity 126b of conduit 126, which draws foam from foam conduit 128 through orifice 130.

To control the magnitude of the vacuum pressure in conduit 126, metering assembly 132 includes a metering insert 150 with a central passageway 152, which is in communication with cavity 126b of conduit 126 and, further, in communication with a fluid valve 154, such as an air valve. Valve 154 selectively allows a fluid, such as air or water, to enter chamber 126b to vary the vacuum in chamber 126b. Metering insert 150 comprises an annular body which inserts into open end 156 of conduit 126 and, further, includes a reduced neck 158 for receiving the annular collar 160 of valve 154. Positioned between collar 160 and metering insert 150 is a seal 162, such as o-ring seal. A second seal 164, such as an o-ring, is also provided between open end 156 of conduit 126 and collar 160 of valve 154. Therefore, together, metering insert 150 and valve 154 selectively reduce the effective vacuum pressure in chamber 126b and passage 134 by allowing fluid to flow into chamber 126b and, hence, passage 134 to bleed off the vacuum pressure in chamber 126b and passage 134.

In the illustrated embodiment, valve 154 comprises an opened ended annular body 166 with a plurality of openings 168, which allow air to be drawn into chamber 126b through passageway 152 of insert 150. Alternately, valve 154 may be coupled to a hose for selectively delivering water to chamber 126b.

In preferred form, metering insert 150 may be replaced with another metering insert with a different diameter passageway to vary the bleed-off rate of the vacuum pressure to achieve different foam flow rates. For example, in applications where the foam concentrate has a higher concentration of active foaming agents, the amount of foam concentrate that needs to be drawn into the eductor may only comprise a fraction of the amount of foam concentrate required in foams which have a lower concentration of active foaming agents. For example, until relatively recently, a 6% foam was regarded as a conventional foam concentrate; however, more recently, foams have been developed that comprise 3% foams and, in some cases, 1½% foams, such as thermo-gels. As would be understood by those skilled in the art, therefore, the amount of foam that is needed may vary considerably depending on the type of foam that is used. Hence, the required orifice size of fluid delivery device, in this case of the fluid valve, may vary.

While several forms of the invention have been shown and described, other forms will now be apparent to those skilled in the art. For example, in lieu of providing a fixed orifice for the fluid delivery device, the air delivery device orifice may be adjustable. Because the foam does not flow through this orifice, the size of the fluid delivery orifice will not create the same problems associated with the prior art eductors. Therefore, it will be understood that the embodiments shown in the drawing and described above are merely for illustrative purposes, and are not intended to limit the scope of the invention, which is defined by the claims, which follow as interpreted under the principles of patent law including the doctrine of equivalents.

I claim:

1. An inline foam eductor comprising:
a first conduit having an upstream end, a downstream end, and a restriction between said upstream end and said downstream end;
a second conduit in fluid communication with said first conduit downstream of said restriction between said restriction and said downstream end of said first conduit wherein fluid flowing through said first conduit through said restriction generates a venturi effect to thereby form a vacuum pressure in said second conduit;
a foam supply conduit in fluid communication with said second conduit; and
a metering device operable to reduce the vacuum pressure in said second conduit to adjust the amount of foam drawn from said foam supply conduit into said first conduit through said second conduit.

2. The inline foam eductor according to claim 1, wherein said metering device is operable to introduce a fluid into said second conduit to thereby reduce the vacuum pressure in the second conduit.

3. The inline foam eductor according to claim 2, wherein said metering device is operable to introduce a fluid into said second conduit.

4. The inline foam eductor according to claim 3, wherein said metering device comprises a valve.

5. The inline foam eductor according to claim 4, wherein said valve comprises a needle valve.

6. The inline foam eductor according to claim 4, wherein said valve comprises an air valve.

7. The inline foam eductor according to claim 5, wherein said second conduit includes a fixed diameter orifice through which said second conduit is in fluid communication with said foam supply conduit.

8. The inline foam eductor according to claim 3, wherein said metering device includes a removable insert, said insert including said fixed diameter orifice.

9. The inline foam eductor according to claim 1, wherein said second conduit includes an orifice through which said foam supply conduit is in fluid communication with said second conduit.

10. The inline foam eductor according to claim 9, wherein said orifice comprises a fixed diameter orifice.

11. An eductor comprising:
a first conduit in fluid communication with a fluid delivery device;
a second conduit in fluid communication with said first conduit, said second conduit having a vacuum pressure formed therein;
a device for selectively adjusting the vacuum pressure in said second conduit; and
a fluid supply in fluid communication with said second conduit, said device selectively adjusting the vacuum pressure in said second conduit to adjust the flow of fluid from said fluid supply to said second conduit and thereby adjust the flow of fluid from said second conduit to said first conduit.

12. The eductor according to claim 11, wherein said device comprises a metering device.

13. The eductor according to claim 11, wherein said device comprises a valve.

14. The eductor according to claim 13, wherein said valve comprises an electrically controlled valve.

15. The eductor according to claim 14, further comprising a control in communication with said electrically controlled valve for controlling said electrically controlled valve.

16. The eductor according to claim 15, wherein said control comprises a remote control in communication with said electrically controlled valve through RF communication or through electrical wiring.

17. The eductor according to claim 11, wherein said device includes a removable insert, said insert having a fluid passageway in communication with said second conduit and selectively in communication with a supply of fluid for allowing fluid flow into the conduit to thereby vary the vacuum pressure in said second conduit, said insert being removable and replaceable with another insert with a different size fluid passageway to vary the bleed-off rate of the vacuum pressure in said second conduit.

18. The eductor according to claim 11, wherein said second conduit is in fluid communication with said fluid supply through a fixed orifice.

19. The eductor according to claim 11, wherein said second conduit is in fluid communication with a foam supply, said device selectively adjusting the vacuum pressure in the second conduit to adjust the flow of foam into said second conduit.

20. A method of educting a fluid into a fluid delivery device, said method comprising:
providing a conduit in fluid communication with the fluid delivery device;
providing fluid communication between the conduit and a fluid supply;
forming a vacuum pressure in the conduit wherein fluid from the fluid supply is drawn into the conduit with said vacuum pressure; and
adjusting the vacuum pressure in the conduit to vary the flow of fluid into the conduit from the fluid supply and to vary flow into the fluid delivery device.

21. The method according to claim 20, wherein said adjusting the vacuum pressure includes introducing a fluid into the conduit.

22. The method according to claim 21, wherein said introducing a fluid includes introducing air or water into the conduit.

23. The method according to claim 20, further comprising providing a metering device to control the flow of fluid into the conduit.

24. The method according to claim 23, wherein said providing fluid communication between the conduit and a fluid supply comprises providing fluid communication between the conduit and a foam or water/foam supply.

25. The method according to claim 20, wherein said providing fluid communication includes providing fluid communication through a fixed diameter orifice.
